(19) United States
(12) Patent Application Publication
(10) Pub. No.: US 2025/0150918 A1
(43) Pub. Date: May 8, 2025

(54) BEAM MANAGEMENT FOR DATA TRANSMISSION IN AN INACTIVE STATE

(71) Applicant: Lenovo (Singapore) Pte. Limited, Singapore (SG)

(72) Inventors: Joachim Löhr, Wiesbaden (DE); Alexander Golitschek Edler von Elbwart, Darmstadt (DE); Prateek Basu Mallick, Dreieich (DE); Hyung-Nam Choi, Ottobrunn (DE); Ravi Kuchibhotla, Chicago, IL (US)

(73) Assignee: Lenovo (Singapore) Pte. Limited, Singapore (SG)

(21) Appl. No.: 18/730,224

(22) PCT Filed: Jan. 13, 2023
(86) PCT No.: PCT/IB2023/050336

§ 371 Date: Jul. 18, 2024

Related U.S. Application Data
(60) Provisional application No. 63/300,897, filed on Jan. 19, 2022.

(51) Int. Cl. H04W 36/08; H04B 7/06; H04B 17/318; H04W 36/30; H04W 74/0833; H04W 76/27

(52) U.S. Cl. CPC H04W 36/085; H04B 7/0695; H04B 17/328; H04W 36/305; H04W 74/0833; H04W 76/27

(57) ABSTRACT

Various aspects of the present disclosure relate to a user equipment (UE) that detects, while in a radio resource control inactive state and optionally while in a small data transmission session, that beam information is to be reported to a base station. This detection is performed based on some criteria, such as the current (serving) downlink beam quality dropping below a threshold amount. In response to detecting that beam information is to be reported to the base station, the UE initiates a random access procedure in order to provide the beam information (e.g., one or more candidate beams to switch to) to the base station. This beam information notifies the base station to change to a new serving beam due to, for example, the quality of the current serving beam dropping because of movement of the UE, blockages between the UE and the base station, and so forth.

### RELATED APPLICATION

This application claims priority to U.S. Patent Application Ser. No. 63/300,897 filed Jan. 19, 2022 entitled “Beam Management for Data Transmission in an Inactive State,” the disclosure of which is incorporated by reference herein in its entirety.

### TECHNICAL FIELD

The present disclosure relates to wireless communications, and more specifically to beam management for data transmission in inactive state.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, subslots, slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G.

New radio (NR) supports an inactive state referred to as radio resource control (RRC) inactive (RRC_INACTIVE). UEs with infrequent (periodic and/or non-periodic) data transmission are generally maintained by the network in the RRC_INACTIVE state. In order to transmit data to or receive data from a base station, the UE resumes the connection with the network (i.e., moves to an RRC connected (RRC_CONNECTED) state). Connection setup and subsequent release to RRC_INACTIVE state happens for each data transmission however small and infrequent the data packets are.

In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances. In a positioning system for an NTN, one or more location servers, or components of the location servers, may communicate with one or multiple UEs connected to the NTN over a wireless medium. In some cases, the propagation delays in an NTN can be orders of magnitude longer than those in a typical terrestrial network (TN). Additionally, satellites or any other non-terrestrial transmit-receive points (NT-TRPs), may be moving at high speeds, for example in the case of low-earth orbit (LEO) and medium-earth orbit (MEO) satellite systems. Other non-terrestrial systems, such as geosynchronous satellite systems, may also introduce wireless communication challenges due to NT-TRP movements.

### SUMMARY

The present disclosure relates to methods, apparatuses, and systems that enable a communication device (e.g., a UE, a base station, a network entity) to perform beam management while in the RRC_INACTIVE state. In one or more implementations, while performing a small data transmission (SDT) in the RRC_INACTIVE state, the UE detects that beam information is to be reported to the base station based on some criteria, such as the current (serving) downlink (DL) beam quality dropping below a threshold amount. In response to detecting that beam information is to be reported to the base station, the UE initiates a random access procedure in order to provide the beam information (e.g., one or more candidate beams to switch to) to the base station. By performing this detecting and reporting, the UE notifies the base station when a new serving beam is to be selected due to, for example, the quality of the current serving beam dropping due to mobility, blockages, and so forth.

Some implementations of the method and apparatuses described herein may further include wireless communication at a device (e.g., at a UE), which includes triggering transmission of beam information to a base station in response to a current serving beam for transmitting data between the and the base station having changed while the UE is in an RRC_INACTIVE state, the beam information indicating a new serving beam; initiating a random access procedure; and transmitting the beam information to the base station as part of the random access procedure.

In some implementations of the method and apparatuses described herein, the triggering comprises triggering transmission of the beam information to the base station in response to the serving beam for reception of DL data having changed while the UE is in a SDT session with the base station and in the RRC_INACTIVE state. Additionally or alternatively, the beam information includes a channel state information reference signal (CSI-RS) index corresponding to the new serving beam. Additionally or alternatively, the beam information includes a synchronization signal block (SSB) index corresponding to the new serving beam. Additionally or alternatively, the beam information is transmitted within a medium access control (MAC) control element (CE) indicating one or more candidate beam information. Additionally or alternatively, the candidate beam information is comprised of a synchronization signal block index corresponding to a new candidate beam or a channel-state information reference signal index corresponding to a new candidate beam or a combination thereof. Additionally or alternatively, the beam information includes, as the information indicating the new serving beam, an identity of a candidate DL transmission beam. Additionally or alternatively, the triggering comprises triggering transmission of the beam information in response to determining that the current serving beam has a SSB with a reference signal received power (RSRP) below a threshold. Additionally or alternatively, the initiating the random access procedure comprising triggering a contention free random access (CFRA) to identify the new serving beam to the base station. Additionally or alternatively, the method and apparatuses receive, from the base station, a beam measurement configuration including a periodicity; and check whether to trigger beam measurements to determine whether the current serving beam has changed at the periodicity indicated in the beam measurement configuration. Additionally or alternatively, the checking comprising measuring one or more reference signals (RSs) in order to determine whether to trigger transmission of the beam information. Additionally or alternatively, the checking comprising measuring one or more reference signals for an uplink (UL) configured grant (CG) SDT resource the UE is configured with regardless of whether data is to be transmitted on the CG SDT. Additionally or alternatively, the beam information includes a MAC CE identifying the new serving beam. Additionally or alternatively, the beam information includes a MAC CE identifying the new serving beam, the method and apparatuses further triggering the UE to trigger a random access procedure or a scheduling request (SR) to request uplink shared channel (UL-SCH) resources if there is currently no UL-SCH resource available for transmission. Additionally or alternatively, the method and apparatuses, during a random access channel (RACH) SDT session: check, at a configured periodicity, whether to trigger transmission of the beam information by determining whether the current serving beam has a SSB with an RSRP below a threshold; and in response to determining the current serving beam has a SSB with an RSRP below a threshold, initiating the random access procedure and transmit an indication of the new serving beam to the base station in a RACH preamble. Additionally or alternatively, transmitting comprising transmitting the beam information to the base station during a RACH SDT session by including a RACH preamble corresponding to the new serving beam.

Some implementations of the method and apparatuses described herein may further include wireless communication at a device (e.g., at a base station), which includes receiving beam information from a UE, the beam information being received in response to the UE having detected that a current serving beam for transmitting data between the base station and the UE changed while the UE is in a RRC_INACTIVE state, the beam information indicating a new serving beam; and considering the beam information for subsequent data transmissions to the UE.

In some implementations of the method and apparatuses described herein, the beam information is transmitted within a MAC CE indicating one or more candidate beam information. Additionally or alternatively, the method and apparatuses determine a periodicity at which the UE is to check whether to trigger transmission of the beam information to the base station; and transmit, to the UE, a beam measurement configuration including the periodicity. Additionally or alternatively, the indication of beam information is received while the base station is in a SDT session with the UE. Additionally or alternatively, the beam information includes a CSI-RS index corresponding to the new serving beam. Additionally or alternatively, the beam information includes a SSB index corresponding to the new serving beam. Additionally or alternatively, the beam information includes, as the information indicating the new serving beam, an identity of a candidate DL transmission beam.

### BRIEF DESCRIPTION OF THE DRAWINGS

Various aspects of the present disclosure for beam management for data transmission in an inactive state are described with reference to the following Figures. The same numbers may be used throughout to reference like features and components shown in the Figures.

FIG. 1 illustrates an example of a wireless communications system that supports beam management for data transmission in an inactive state in accordance with aspects of the present disclosure.

FIG. 2 illustrates an example of resuming a connected state to transmit data between a UE and a base station.

FIG. 3 illustrates an example of resuming CG based SDT in the RRC_INACTIVE state.

FIG. 4 illustrates an example of resuming RACH based in the RRC_INACTIVE state.

FIG. 5 illustrates an example of a block diagram of a device that supports beam management for data transmission in an inactive state in accordance with aspects of the present disclosure.

FIG. 6 illustrates an example of a block diagram of a device that supports beam management for data transmission in an inactive state in accordance with aspects of the present disclosure.

FIGS. 7, 8, 9, 10, and 11 illustrate flowcharts of methods that support beam management for data transmission in an inactive state in accordance with aspects of the present disclosure.

### DETAILED DESCRIPTION

Implementations of beam management for data transmission in an inactive state are described, such as related to a wireless system that supports SDT sessions while the UE is in an RRC_INACTIVE state. The RRC_INACTIVE state is a lower power state than the RRC_CONNECTED state but a higher power state than an RRC idle (RRC_IDLE) state. The RRC_INACTIVE state allows the UE to save some power but also allows for transitioning to the RRC_CONNECTED state quicker than when coming from the RRC_IDLE state. An SDT session can be established while the wireless system is in the RRC_INACTIVE state. The SDT session allows some data to be transferred between the UE and the base station without needing the UE to transition to the RRC_CONNECTED state.

The UE performs beam management while in the RRC_INACTIVE state and in an SDT session, as well as while in the RRC_INACTIVE state but not in an SDT session. Beam management refers to various aspects of selecting a beam to use to transmit data between the UE and a base station, such as checking whether a current serving beam needs to be changed, identifying one or more candidate beams, transmitting beam information identifying a new serving beam to the base station, and so forth.

The UE detects, while in the RRC_INACTIVE state and optionally while in an SDT session, that beam information is to be reported to the base station. This detection is performed based on some criteria, such as the current (serving) DL beam quality dropping below a threshold amount. In response to detecting that beam information is to be reported to the base station, the UE initiates a random access procedure in order to provide the beam information (e.g., one or more candidate beams to switch to) to the base station. This beam information notifies the base station to change to a new serving beam due to, for example, the quality of the current serving beam dropping because of movement of the UE, blockages between the UE and the base station, and so forth. The base station considers the beam information in subsequent data transmission to the UE, for example, by changing to a serving beam identified in the beam information.

The UE determines to check whether beam information is to be reported to the base station in any of a variety of different manners. In one or more implementations, the UE receives a beam measurement configuration from the base station. The beam measurement configuration includes a periodicity and the UE checks at the indicated periodicity whether beam information is to be reported to the base station.

The quality of the current serving beam may drop for any of various reasons, such as movement of the UE, blockages between the UE and the base station, and so forth. One technique for implementing SDT sessions is to not allow the UE to transmit beam information to the base station during an SDT session. Accordingly, such wireless systems are not able to account for the quality of the current serving beam dropping. By detecting and notifying the base station when to change to a new serving beam, the techniques discussed herein allow the base station to change to a new serving beam with higher quality for the SDT session.

Furthermore, another technique for implementing SDT sessions implicitly indicates beam information with the UL data using the configured grant physical uplink shared channel (CG-PUSCH) resources selected (e.g., the SSB to CG-PUSCH mapping). However, in some situations, such as a mobile terminated (MT) triggered (e.g., DL) SDT session there might not be UL data available for transmission in the UE. Therefore, UL transmissions cannot be used for the provisioning of beam information during an SDT session, e.g. during a CG based SDT session. As a consequence, it might not be possible to indicate a change of the serving beam which is used for the reception of data and control during the SDT session. By detecting and notifying the base station when to change to a new serving beam regardless of whether the SDT session is MT triggered or mobile originated (MO) triggered (e.g., UL), the techniques discussed herein allow the base station to change to a new serving beam with higher quality for the SDT session.

Aspects of the present disclosure are described in the context of a wireless communications system. Aspects of the present disclosure are further illustrated and described with reference to device diagrams and flowcharts that relate to beam management for data transmission in an inactive state.

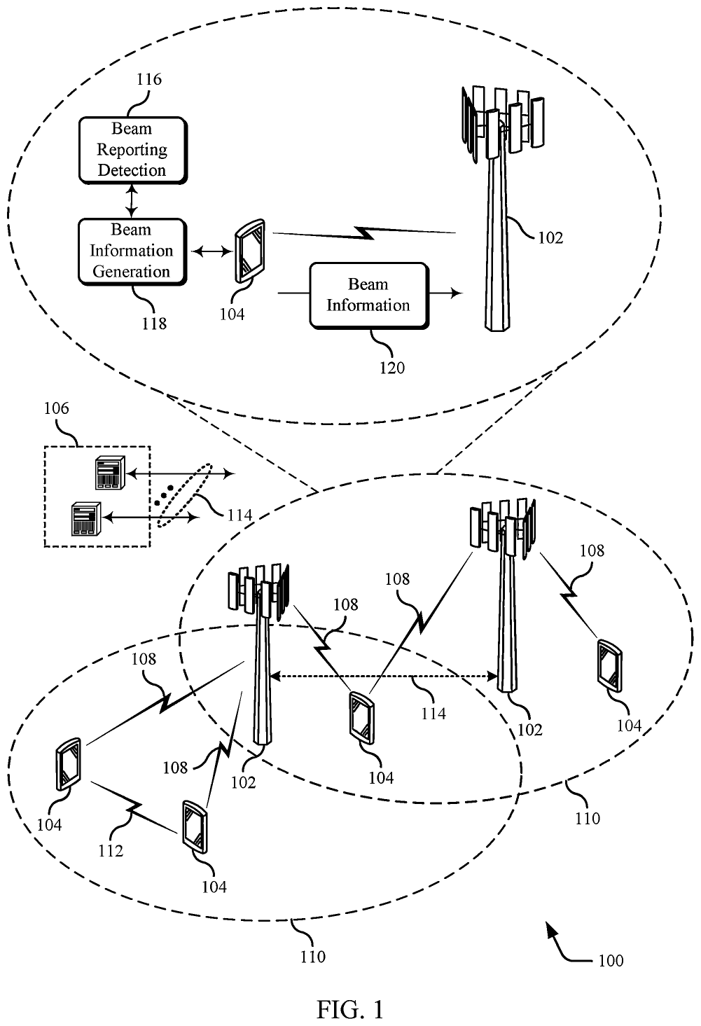

FIG. 1 illustrates an example of a wireless communications system 100 that supports beam management for data transmission in an inactive state in accordance with aspects of the present disclosure. The wireless communications system 100 may include one or more base stations 102, one or more UEs 104, and a core network 106. The wireless communications system 100 may support various RATs. In some implementations, the wireless communications system 100 may be a 4G network, such as an LTE network or an LTE-A network. In some other implementations, the wireless communications system 100 may be a 5G network, such as a NR network. In other implementations, the wireless communications system 100 may be a combination of a 4G network and a 5G network. The wireless communications system 100 may support RATs beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNB, a gNB, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UE 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite associated with an NTN. In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment, a subscriber device, or some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100, such as a very small aperture terminal (VSAT), which may be connected to one or multiple other network nodes serving other UEs. In other implementations, a UE 104 may be mobile in the wireless communications system 100.

The one or more UEs 104 may be devices in different forms or having different capabilities. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, TRPs, and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations for beam management for data transmission in an inactive state a UE 104 can identify beams for communication with a base station 102 while performing an SDT in the RRC_INACTIVE state. For instance, in the wireless communications system 100, the UE 104 performs beam reporting detection 116 to determine when beam information is to be reported to the base station 102. The UE 104 performs beam reporting detection 116 in any of a variety of manners as discussed in more detail below.

The UE 104 performs beam information generation 118 on one or more beams received from the base station 102. As part of the beam information generation 118, for instance, the UE 104 measures different attributes of the one or more beams received from the base station 102, such as RSRP, reference signal received quality (RSRQ), received signal strength indicator (RSSI), signal-to-interference and noise ratio (SINR), and so forth, to determine measurements for the one or more beams.

The UE 104 communicates the beam information 120 to the base station 102 and wireless communication is established between the base station 102 and the UE 104 utilizing one or more beams identified in the beam information 120.

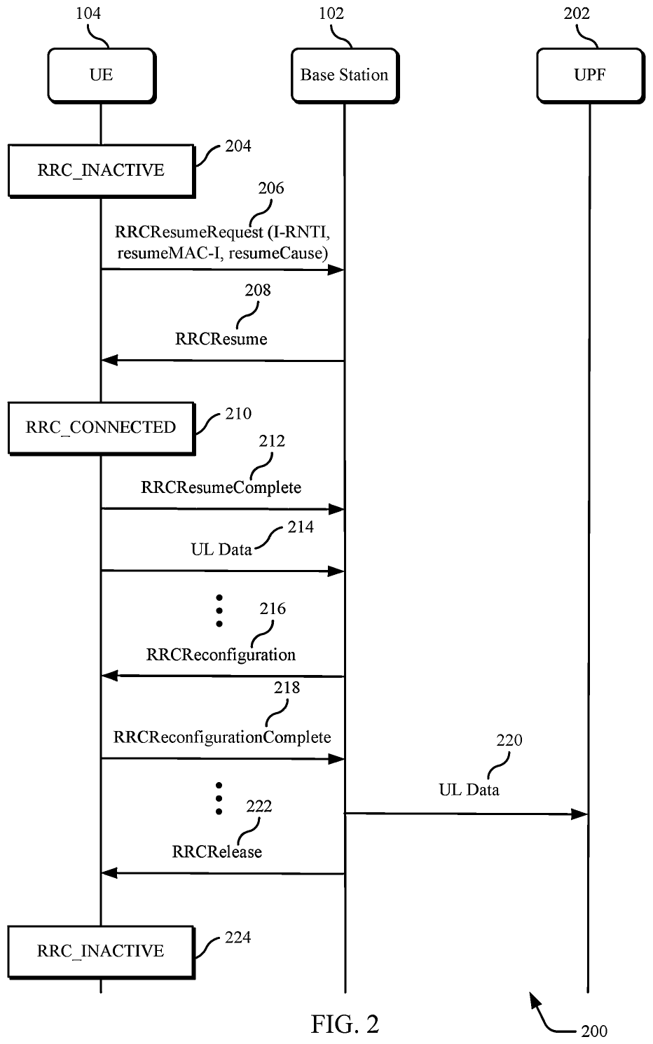

FIG. 2 illustrates an example 200 of resuming a connected state to transmit data between a UE and a base station. The example 200 illustrates communication involving the UE 104, a base station 102, and a user plane function (UPF) 202.

At 204, the UE 104 is in the RRC_INACTIVE state.

At 206, the UE 104 transmits an RRCResumeRequest to the base station 102 to resume the connected state. The RRCResumeRequest includes an inactive-radio network temporary identifier (I-RNTI) parameter, an Authentication token to facilitate UE authentication at the base station 102 (resumeMAC-I) parameter, and a cause parameter (resumeCause).

At 208, the base station 102 transmits a RRCResume response indicating to the UE 104 to enter the RRC_CONNECTED state.

At 210, the UE 104 enters the RRC_CONNECTED state.

At 212, the UE 104 transmits an RRCResumeComplete indication to the base station 102 notifying the base station 102 that the UE 104 has entered the RRC_CONNECTED state.

At 214, the UE 104 transmits UL data 214 to the base station 102.

At 216, the base station 102 communicates an RRCReconfiguration indication to the UE 104 notifying the UE 104 to modify the RRC connection, e.g. to establish/modify/release radio bearers (RBs), to perform reconfiguration with sync, to setup/modify/release measurements, and to add/modify/release secondary cells (SCells) and cell groups.

At 218, the UE 104 transmits an RRCReconfiguration Complete indication 218 to the base station 102 notifying the base station that the UE 104 has received and executed the RRCReconfiguration message.

At 220, the base station 102 transmits the data received from the UE 104 to the UPF 202.

At 222, the base station 102 transmits an RRCRelease indication to the UE 104 notifying the UE 104 that the UE 104 can return to the RRC_INACTIVE state.

At 224, the UE 104 enters the RRC_INACTIVE state.

The example 200 results in unnecessary power consumption and signaling overhead, particularly in situations in which the amount of UL data at 214 is relatively small. For example, the UL data at 214 may be only two or three Transport Blocks. Accordingly, SDTs can be used to transmit data between the UE 104 and base station 102.

In one or more implementations, for SDT while the UE 104 is in the RRC_INACTIVE state, for a RACH, e.g., 2-step or 4-step RACH, the following applies: 1) a general procedure to enable UP data transmission for small data packets from the RRC_INACTIVE state is supported (e.g. using MSGA or MSG3 in 4-step RACH); 2) flexible payload sizes larger than the Rel-16 common control channels (CCCH) message size that is possible for the RRC_INACTIVE state for MSGA and MSG3 is enabled to support UP data transmission in UL (the actual payload size can be up to network configuration); and 3) context fetch and data forwarding (with and without anchor relocation) in the RRC_INACTIVE state for RACH-based solutions is supported.

In one or more implementations, for SDT while the UE 104 is in the RRC_INACTIVE state, for transmission of UL data on pre-configured physical uplink shared channel (PUSCH) resources (e.g., reusing the configured grant type 1), when time alignment (TA) is valid, the following applies: 1) a general procedure for small data transmission over configured grant type 1 resources from the RRC_INACTIVE state is supported; and 2) configuration of the configured grant typel resources for small data transmission in UL for the RRC_INACTIVE state is supported.

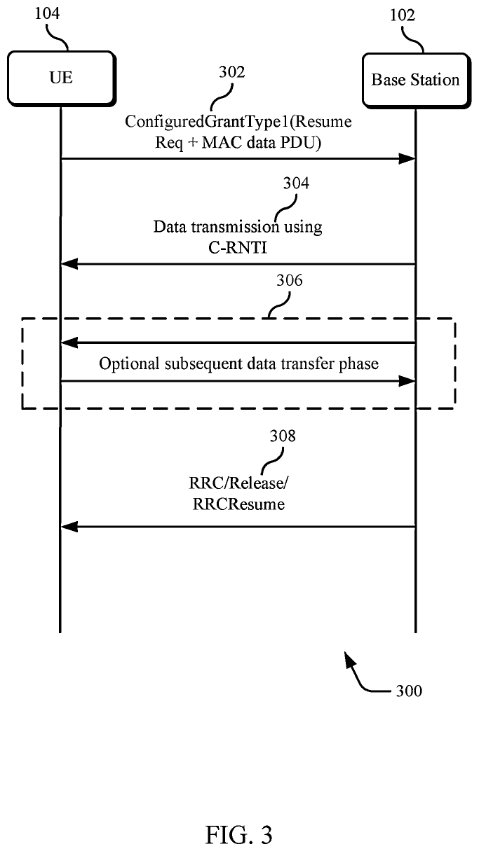

FIG. 3 illustrates an example 300 of resuming CG based SDT in the RRC_INACTIVE state. The example 300 illustrates communication involving the UE 104 and a base station 102.

At 302, the UE 104 transmits the initial SDT message, e.g. a RRCResumeRequest message and optionally some UL data, to the base station 102 to initiate an SDT session. The initial SDT message is transmitted on the pre-allocated resources, e.g. ConfiguredGrant type 1 resources (CG PUSCH resources). The initial SDT message includes as parameters a request to Resume the RRC connection (Resume Req), and UL data which are transmitted as medium access control (MAC) protocol data unit (PDU) data (MAC data PDU).

At 304, the base station 102 sends a data transmission to the UE 104 using cell-radio network temporary identifier (C-RNTI).

At 306, one or more data transmissions are optionally made from the UE 104 to the base station 102, or from the base station 102 to the UE 104.

At 308, the base station 102 transmits an RRCRelease or RRCResume indication to the UE 104 notifying the UE 104 that the SDT session has ended.

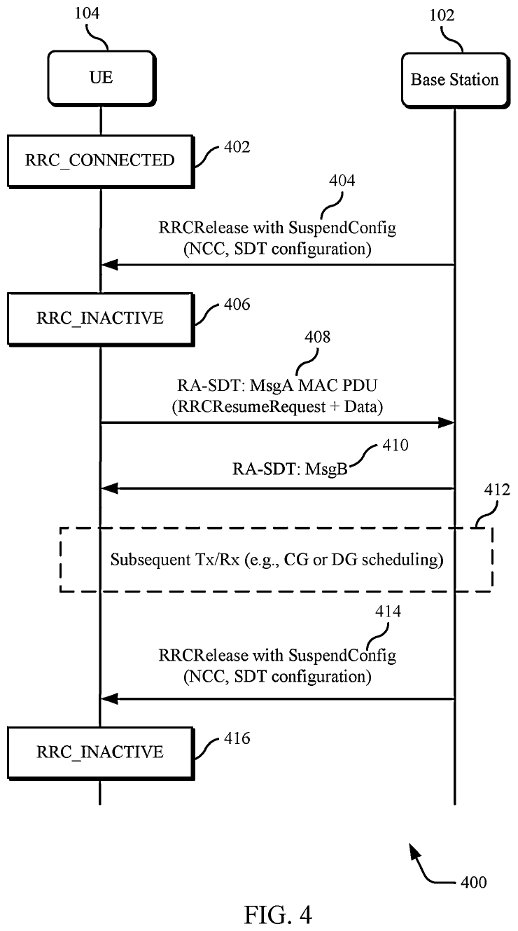

FIG. 4 illustrates an example 400 of resuming RACH based SDT in the RRC_INACTIVE state. The example 400 illustrates communication involving the UE 104 and a base station 102.

At 402, the UE 104 is in the RRC_CONNECTED state.

At 404, the base station 102 transmits an RRCRelease with SuspendConfig indication to the UE 104. The RRCRelease with SuspendConfig indication notifies the UE 104 to enter the RRC_INACTIVE state.

At 406, the UE 104 is in the RRC_INACTIVE state.

At 408, the UE 104 transmits an RA-SDT message to the base station 102. The RA-SDT message is a physical random access channel (PRACH) preamble or a PRACH preamble and some uplink data transmission, e.g. msgA in a 2-step RACH procedure. The UL data transmission, e.g. msga-PUSCH contains the RRCResumeRequest message and optionally some UL data.

At 410, the base station 102 transmits an Rach Response message to the UE 104. In a 2-step RACH procedure the response message is a MsgB message.

At 412, one or more data transmissions are optionally made from the UE 104 to the base station 102, or from the base station 102 to the UE 104. These are done, for example, using CG or dynamic grant (DG) scheduling.

At 414, the base station 102 transmits an RRCRelease with SuspendConfig indication to the UE 104. The RRCRelease with SuspendConfig indication notifies the UE 104 to enter the RRC_INACTIVE state.

At 416, the UE 104 is in the RRC_INACTIVE state.

In one or more implementations, for SDT while the UE 104 is in the RRC_INACTIVE state, paging-triggered SDT (also referred to as mobile terminated SDT (MT-SDT) is supported. In such implementations, the following applies: 1) MT-SDT triggering mechanism for UEs 104 in the RRC_INACTIVE state, with random access SDT (RA-SDT) and CG SDT (also referred to as CG-SDT) as the UL response are supported; and 2) MT-SDT procedure for initial DL data reception and subsequent UL/DL data transmissions in the RRC_INACTIVE state are supported. For UL SDT the change of a beam, i.e. the beam which is selected by the UE 104 for the reception/transmission of control/data, could be implicitly indicated by CG-PUSCH resources selected (e.g., using SSB-CG-PUSCH mapping). During the subsequent new CG transmission phase, for the purpose of CG resource selection, UE re-evaluates the SSB for subsequent CG transmission.

In one or more implementations, for SDT while the UE 104 is in the RRC_INACTIVE state, the following applies:
1. For small data, for RACH and CG based solutions when the UE 104 receives RRC release with Suspend config, the UE 104 at least performs the following actions (i.e. same action as in legacy): MAC is reset and default MAC cell group configuration is released, radio link control (RLC) entities for signalling radio bearer (SRB) 1 (SRB1) are re-established, SRBs and data radio bearers (DRBs) are suspended except SRB0.
2. For both RACH and CG based solutions, upon initiating RESUME procedure for SDT initiation (i.e. for first SDT transmission), the UE 104 shall re-establish at least the SDT packet data convergence protocol (PDCP) entities and resume the SDT DRBs that are configured for small data transmission (along with the SRB1).
3. The first UL message (i.e. MSG3 for 4-step RACH, MSGA payload for 2-step RACH and the CG transmission for CG) may contain at least the following contents (depending on the size of the message): CCCH message. Logical channel prioritization procedure (LCP) can be used to determine priority of the following content that may be included: DRB data from one or more DRBs which are configured by the network for small data transmission; MAC CEs (e.g. buffer status reporting (BSR)); padding bits.
4. For RACH and CG, the existing unified access control (UAC) procedure to determine whether access attempt is allowed, will be reused for SDT.
5. SDT is transparent to the non-access stratum (NAS) layer (i.e. NAS generates one of the existing resume causes and AS decides SDT vs non-SDT access).
6. In case of RRC-based solution, for both RACH and CG based solutions, the CCCH message contains ResumeMAC-I generated using the stored security key for RRC integrity protection—i.e same as Rel-16.
7. For both RACH and CG based solutions, new keys are generated using the stored security context and the Next Hop Chaining Counter (NCC) value received in the previous RRCRelease message (i.e. same as legacy procedure) and these new keys are used for generating the data of DRBs that are configured for SDT.
8. For RACH based solutions, upon successful completion of contention resolution, the UE shall monitor the C-RNTI.
9. As a baseline, the RACH resource i.e. (RACH occasion (RO) +preamble combination) is different between SDT and non-SDT. If ROs for SDT and non SDT are different, preamble partitioning between SDT and non SDT is not needed. If ROs for SDT and non SDT are same, preamble partitioning is needed.
10. If the RACH resource i.e. (RO+preamble combination) is different between SDT and non-SDT then there is no further need for any differentiation between MSG2/MSGB for SDT vs non-SDT

In one or more implementations, for SDT while the UE 104 is in the RRC_INACTIVE state, the following applies:
1. The configuration of CG resource for UE UL SDT is contained in the RRCRelease message. Configuration is only type 1 CG with no contention resolution procedure for CG.
2. The configuration of CG resource can include one type 1 CG configuration.
3. A new TA timer for TA maintenance specified for CG based SDT in RRC_INACTIVE is introduced. The TA timer is configured together with the CG configuration in the RRCRelease message.
4. The configuration of CG resource for UE SDT is valid only in the same serving cell.
5. The UE can use CG based SDT if at least the following criteria is fulfilled: (a) user data is smaller than the data volume threshold; (b) CG resource is configured and valid; and (c) UE has valid TA.
6. An association between CG resources and SSBs is made for CG-based SDT.
7. A synchronization signal reference signal received power (SS-RSRP) threshold is configured for SSB selection. UE selects one of the SSB with SS-RSRP above the threshold and selects the associated CG resource for UL data transmission.

In one or more implementations, for SDT while the UE 104 is in the RRC_INACTIVE state, the following applies:
1. The Rel-16 CG configuration mechanism in licensed band is reused the baseline for CG-SDT.
2. At least for initial transmission use a mechanism to allow the UE to transmit the message again.
3. The UE uses/selects the same hybrid automatic repeat request (HARQ) process for retransmission.
4. The “CG-SDT timer” starts at the first “valid” physical downlink control channel (PDCCH) occasion from the end of the CG-SDT PUSCH transmission.
5. The “CG-SDT timer” can be started/restarted during for initial and subsequent transmissions.
6. The UE restarts the “CG-SDT timer” at least: upon the PUSCH retransmission indicated by the configured scheduling radio network temporary identifier (CS-RNTI) PDCCH, and after each CG-SDT transmission.
7. The “CG-SDT timer” stops at least when the UE receives RRC feedback messages (e.g. RRCResume, RRCSetup, RRCRelease and RRCReject).
8. The Rel-16 calculation on the HARQ process ID of the CG type-1 for licensed band is reused as the baseline for CG-SDT.
9. The UE is allowed to initiate subsequent UL data transmission only after the reception of confirmation of initial transmission from the base station.
10. The UE can use multiple CG resources for the HARQ initial transmission as Rel-16 in the subsequent CG transmission phase.
11. The following CG-SDT configurations are per UE: the new TA timer in RRC_INACTIVE, the RSRP change threshold for TA validation mechanism in SDT, the SSB RSRP threshold for beam selection.

In case of low/mid frequency region without using massive antenna array, a single transmission would cover multiple UEs 104 simultaneously. However, when the radiation becomes beam-shaped, e.g., in high frequency bands like frequency range 2 (FR2), it is very difficult to cover multiple UEs 104 in a single transmission unless those multiple UEs 104 are located in very close proximity. As the carrier frequency is increasing, the propagation gets more challenging as the pathloss between transmitter and receiver is increasing due to the assumption of a fixed antenna size relative to the wavelength. Further, beyond 10Ghz reflections and scattering will be the most important propagation mechanism for non-line-of-sight (NLOS) communication. To handle this problem, the beam is managed/controlled to cover the multiple devices scattered in all directions and the management/control mechanism can be different depending on the situations. Beam management is understood as a set of Layer 1 and Layer 2 procedures to acquire and maintain a set of beams at both transmitter and receiver which are used for the transmission of control and data channels. Beam management consists of a set of procedures which are valid for both the base station 102 and the UE 104:
1. Beam determination is performed first by both transmitter and receiver. This implies identification of best beam for transmission and reception of data, e.g. as an outcome of the beam sweeping procedure. A concept of this procedure is the beam correspondence.
2. Beam measurement implies obtaining the characteristics, e.g. power, of the received beamformed signals.
3. Beam reporting leads to the transmission of a beam measurement report to the transmitter.

According to legacy 3GPP standards (Rel-16), the UE is providing beam measurements for the purpose of DL/UL beam selection. L1-RSRP measurements are used for that purpose: for DL beam selection; for UL beam and panel selection where the UE would determine reported DL RS indices (together with measurement result and panel identifier).

The network (NW), such as the base station 102 or the core network 106, configures beam (group) reporting for the UE 104, i.e. CSI-RS resource indicator (CRI). The NW configures for which CRIs the UE 104 shall report, e.g. L1-RSRP. In Rel-15 the NW can configure CSI reporting for beam reporting with different types of time periodicities, including periodic, semi-persistent, and aperiodic. The payload sizes of the beam report can vary according to the number of reported and measured CSI resources as well as whether differential or non-differential coding is used. Table I indicates example CSI reporting activations with different CSI-RS configurations.

TABLE I

| | Periodic | | |
|---|---|---|---|
| CSI-RS | CSI | Semi-persistent | Aperiodic CSI |
| configuration | Reporting | CSI reporting | reporting |
| Periodic | No dynamic | For PUCCH based | DCI can activate |
| CSI-RS | activation | reporting, MAC CE | reporting. |
| | | activates. For | Additionally, MAC |
| | | PUSCH based | CE can also active |
| | | reporting, downlink | it. |
| | | control indicator | |
| | | (DCI) activates. | |
| Semi- | Not supported | For PUCCH based | DCI can activate |
| Persistent | | reporting, MAC CE | reporting. |
| CSI-RS | | activates. For | Additionally, MAC |
| | | PUSCH based | CE can also activate |
| | | reporting, DCI | it. |
| | | activates. | |
| Aperiodic | Not supported | Not supported | DCI can activate |
| CSI-RS | | | reporting. |
| | | | Additionally, MAC |
| | | | CE can also activate |
| | | | it. |

To recover from the rapid interruptions of connectivity, an alternative candidate link may exist between the UE 104 and the base station 102 and to re-establish or reconnect the beam failure recovery (BFR) procedure has been specified. In the beam recovery procedure the UE 104 monitors the radio link by estimating the hypothetical quality of the DL control channels based on a set of periodically referenced signals, i.e. beam failure detection reference signal (BFD-RS). When the UE 104 estimates that the quality of the link is not adequate to maintain reliable communication, the UE 104 declares beam failure. The BFD-RS are configured by NW similar to radio link monitoring reference signal (RLM-RS). For BFD-RS only periodic channel state information reference signal (CSI-RS) that are quasi-co-located with the PDCCH Demodulation Reference Signal (DM-RS) can be used. The quality of a BFD-RS is compared against a threshold Q_{out_LR}, e.g., 10% block error rate (BLER) of hypothetical PDCCH.

The new candidate beam is selected based on received signal strength, even though the beam failure detection (BFD) metric is based on perceived reception quality (considering also interference). The candidate beam is selected by MAC based on Layer 1 RSRP (L1-RSRP) measurements provided by the physical layer (PHY). If the UE 104 has been configured with candidate beam list, the UE 104 checks first if the L1-RSRP of any of the CFRA candidates is above a configured threshold. If no CFRA candidate, the UE 104 performs contention-based random access (CBRA) based recovery. In CBRA recovery the UE 104 indicates an SSB to the base station 102 by transmitting the corresponding preamble. The CBRA recovery is a normal RACH procedure where the SSB is selected based on L1-RSRP measurements.

While in the RRC_INACTIVE state, the UE 104 detects that beam information is to be reported to the base station 102 based on some criteria. In response to detecting that beam information is to be reported to the base station 102, the UE 104 initiates a random access procedure in order to provide the beam information (e.g., one or more candidate beams to switch to) to the base station 102. The UE 104 detects that beam information (also referred to as a beam information report) is to be reported to the base station 102 and provides the beam information to the base station 102 in any of a variety of different manners.

In one or more implementations, the UE 104 triggers the transmission of beam information based on some predefined or preconfigured conditions when the UE 104 is in the RRC_INACTIVE state. Additionally or alternatively, the UE 104 triggers the transmission of beam information (a beam information report) based on some criteria while the UE 104 is in an SDT session in the RRC_INACTIVE state. In one example, the UE 104 triggers the report of DL beam information to the base station 102 in situations where the serving beam, e.g., the most recent beam used for transmission of data and/or control information to the UE 104, changes during an SDT session. The serving beam is, for example, a DL beam and the beam information is comprised of a set of one or more candidate DL beams. The UE 104 can evaluate during an SDT session a set of one or more candidate DL beams when certain criteria have been fulfilled. In one example such conditions or criteria may be one of the following or a combination thereof, where the combination may be a logical AND combination or a logical OR combination:
Current (serving) DL beam quality dropped by more than a configured threshold, e.g., RSRP of serving beam dropped by more than X dB (e.g., 10 dB);
RSRP of current serving DL beam is below a configured threshold;
RSRP/RSRP of SSB as indicated by random access procedure triggered for RACH-SDT, e.g., RACH resource used for msg1/MsgA, has dropped below a preconfigured threshold.

In one or more implementations, one or more of the criteria are required to be fulfilled for at least a number of corresponding measurement occasions or a pre-defined duration. For example, the second exemplary criterion may be modified such that the RSRP of current serving DL beam is below a configured threshold for at least two subsequent RSRP measurements for the current serving beam.

Once the predefined criteria related to the current (serving) DL beam have been met, the UE 104 initiates a procedure to indicate to the base station 102 a new suitable DL beam in order to sustain a sufficiently good link quality. In one or more implementations, the UE 104 triggers a random access procedure in order to inform the base station 102 about one or more candidate beams. A new RACH trigger is defined for cases when predefined criteria related to the current (serving) DL beam have been met. A mapping of RACH preambles to SSBs is maintained, allowing the UE 104 to implicitly identify a new suitable DL beam (based on the SSB of the new beam). In one example the UE 104 performs CBRA to indicate candidate beams where the UE 104 indicates to the base station 102 an SSB by transmitting a corresponding preamble/RACH resource.

For determining the RACH resource the UE 104 may select an SSB with L1-RSRP above a predefined RSRP threshold and use a RACH resource (a RACH occasion) corresponding to the selected SSB. The predefined threshold may be the same as used for the initial SDT selection/RACH procedure or alternatively a separate additional RSRP threshold may be configured for the beam candidate selection. The corresponding RACH msg3 or the PUSCH in a MsgA may be comprised of a C-RNTI MAC CE (for contention resolution) and optionally a BSR MAC CE. In one example a new MAC CE is contained in the msg3 or MsgA which indicates candidate beam information. Such beam information may be in one implementation the index of the SSB which was selected during RACH procedure, e.g., the UE 104 transmitted corresponding RACH preamble. In another example the MAC CE indicates the index of the SSBs with SS-RSRP above a preconfigured threshold. Additionally or alternatively, the MAC CE may indicate the index of the CSI-RS or other RS with reference signal received power (RSRP) above a preconfigured threshold. In one implementation the base station 102 may configure a list of candidate beams (reference signal). The UE 104 may indicate which of the RSRP of the beams within the list of candidate beams are above a preconfigured threshold. Additionally or alternatively, a new MAC CE indicating a cause value is introduced. The purpose of the MAC CE is to inform base station 102 explicitly of the reason why the UE 104 triggered a RACH procedure during the SDT session. The reason may be one or more of the criteria defined for triggering the report, e.g., the reason may indicate that the RSRP of the current serving DL beam is below a configured threshold. The new beam candidate information reporting is considered as successfully completed when contention resolution is successfully completed and RACH procedure is completed.

In one implementation of this embodiment, the UE 104 triggers a CFRA in order to inform the base station 102 about one or more candidate beams, e.g., when predefined criteria related to, for example, the current serving beam quality are met. In one example the base station 102 provides the UE 104 with a list of candidate beams for new beam identification. Each candidate beam (reference signal) may be associated with a contention-free RACH preamble/resource. By transmitting a dedicated preamble the UE 104 indicates to the base station 102 a new beam candidate and since the preamble is dedicated the preamble also implicitly identifies the UE 104 to the base station 102. When the CFRA is carried out in order to indicate new beam candidates no specific response is provided by the network (like for the case of BFR) and legacy CFRA is performed. Candidate beam indication is considered as successful when the case random access response message is successfully received by the UE 104. In one or more implementations the UE 104 skips the UL grant received in the random access response (RAR) for cases that the UE 104 has no uplink data available for transmission. Additionally or alternatively, the RAR sent by the base station 102 in response to the reception of a new candidate beam information is comprised of a MAC subheader with a random access preamble identifier (RAPID) only (i.e., acknowledgment for candidate beam information). Essentially, there is no MAC RAR contained in the RACH response message/MsgB.

In one or more implementations, the UE 104 monitors PDCCH and physical downlink shared channel (PDSCH) using the quasi-colocation (QCL) assumption of indicated candidate beam, until a new transmission configuration indicator (TCI) state for PDCCH is indicated. For UL transmissions the same spatial filter as was used for indicating the new candidate beam is used by the UE 104 until a new reconfiguration is received from the NW.

In one or more implementations, the UE 104 triggers a beam recovery procedure (e.g. as specified for the legacy Rel-16 specifications) for cases that the serving beam has changed or the reception quality of the current serving beam is not considered sufficient anymore. In one example the UE 104 evaluates during an SDT session one or more candidate DL beams when certain criteria have been fulfilled to trigger the beam recovery procedure. As mentioned above such criteria may be, e.g., one of the following or a combination thereof, where the combination may be a logical AND combination or a logical OR combination:
Current (serving) DL beam quality dropped by more than a configured threshold, e.g. RSRP of serving beam dropped by more than X dB (e.g., 10 dB);
RSRP of current serving DL beam is below a configured threshold;
SSB as indicated by random access procedure triggered for RACH-SDT, e.g., RACH resource used for msg1/MsgA, has dropped below a preconfigured threshold.

In one or more implementations, one or more of the criteria are required to be fulfilled for at least a number of corresponding measurement occasions or a pre-defined duration. For example, the second exemplary criterion may be modified such that the RSRP of current serving DL beam is below a configured threshold for at least two subsequent RSRP measurements for the current serving beam.

Once the predefined criteria related to the current (serving) DL beam as described above have been met, the UE 104 initiates the beam recovery procedure in order to indicate to the base station 102 a new suitable (DL) beam in order to sustain a sufficiently good link quality.

Additionally or alternatively, the UE 104 is configured with a beam measurement configuration which is at least comprised of a periodicity. The beam measurement configuration indicates how often (e.g., a periodicity) the UE 104 is to measure the beams and evaluate the beams in order to determine a suitable beam for the transmission of data to the UE 104. This beam measurement information is received from the NW, such as from the base station 102. This beam measurement is received in various manners, such as included with an RRCRelease indication notifying the UE 104 that the UE 104 can return to the RRC_INACTIVE state.

In one or more implementations, the UE 104 evaluates SSBs with the configured periodicity for the purpose of determining a suitable SSB (beam) used for the transmission of data and/or control information. Similar to the behavior for UL SDT when the UE 104 is configured with CG SDT resources, where the UE 104 re-evaluates the SSBs, e.g., RSRP of SSBs, for every CG transmission for the purpose of CG resource selection, the UE 104 performs an SSB evaluation with a given configured periodicity for the purpose of candidate beam selection even for cases when the UE 104 is not configured with CG SDT resources. In one example the UE 104 (virtually) performs the actions for CG SDT in terms of SSB evaluation in order to select beam candidates and to indicate those to the base station 102. This procedure is particularly beneficial for MT triggered SDT (DL SDT) when the UE 104 has no uplink data available for transmission. In one example the UE 104 selects one of the SSBs with SS-RSRP above a configured threshold. The UE 104 does this re-evaluation of SSBs and re-selection of (serving) SSBs respectively with the periodicity provided by the beam measurement configuration. In situations where the selected SSB/beam has changed compared to the previous SSB evaluation/selection, the UE 104 indicates to the base station 102 the newly selected SSB/beam. In one or more implementations, the UE 104 triggers the transmission of a beam candidate MAC CE which indicates the selected SSB/Beam, e.g., an index/identifier of the selected SSB. Additionally or alternatively, the MAC CE signals the index of the SSBs whose SS-RSRPs are above the configured threshold. If there is no UL-SCH resource available for the transmission of the beam candidate MAC CE, the UE 104 triggers a random access procedure or an SR for beam candidate indication in order to request UL-SCH resources for the transmission of the beam candidate MAC CE.

The network (e.g., the base station 102) determines the periodicity to include in the beam measurement configuration in any of a variety of different manners. In one or more implementations, in the inactivate state the UE 104 monitors for paging reception at a particular periodicity (e.g., a paging periodicity). The periodicity to include in the beam measurement configuration is, for example, similar to or the same as the paging periodicity. Additionally or alternatively, in the inactive state the UE 104 checks measurements for radio resource management at a particular periodicity (e.g., a radio resource management periodicity) to determine whether to connect to a different cell. The periodicity to include in the beam measurement configuration is, for example, similar to or the same as the radio resource management periodicity.

In one or more implementations, the UE 104 carries out an SSB/beam evaluation/selection for every CG SDT resource for cases when the UE 104 is configured with CG SDT resources and performing a CG SDT procedure even in situations where the UE 104 skips a CG PUSCH transmission due to the absence of UL SDT data available for transmission. The UE 104 selects, for example, one of the SSBs with an SS RSRP above a configured threshold for every configured CG SDT resource (CG-PUSCH) during a CG SDT session. If the selected SSB is different than the previous selected and indicated SSB/beam, the UE 104 triggers the transmission of a beam candidate MAC CE which indicates the new selected beam, e.g. index/ID of the SSB, to the base station 102. The transmission of the beam candidate MAC CE ensures that the base station 102 is provided with beam change information also in the absence of higher layer UL data, e.g. no CG PUSCH transmission on CG SDT resources. Typically, the UE 104 would skip a CG PUSCH transmission if there is no UL data available for transmission in the buffer of the UE 104. Hence there would be no possibility to indicate to the base station 102 a beam change, e.g., a new candidate beam, using the selected CG SDT resource for a PUSCH transmission. It should be noted that for CG SDT there is an association between CG resources and SSBs. For example, the UE 104 selects one of the SSBs with an SS-RSRP above the threshold and selects the associated CG resource for a UL data transmission.

In one or more implementations, the UE 104 evaluates the SSB/beam quality/RSRP with a configured periodicity while the UE 104 is performing a RACH-SDT procedure. Such periodicity may be preconfigured, fixed in standards, provided to the UE 104 in a configuration (such as an RRCRelease message), and so forth. In one or more implementations, the UE 104 evaluates SSBs with the predefined periodicity for the purpose of determining a suitable SSB (beam) used for the transmission of control and data. The UE 104 performs according to this embodiment an SSB evaluation with a given configured periodicity for the purpose of candidate beam selection while the UE 104 is performing a RACH-SDT procedure, e.g. during the RACH SDT session. This procedure is in particular beneficial for MT triggered SDT (DL SDT) when the UE 104 has no uplink data available for transmission.

In one example the UE 104 selects one of the SSBs with an SS-RSRP above a configured threshold. The UE 104 does this re-evaluation of SSBs and re-selection of (serving) SSBs beams with the periodicity provided by the configuration or standard. When initiating a RACH SDT procedure (also referred to as a RACH SDT session), the UE 104 selects an SSB and transmits the corresponding RACH msg1 or RACH msgA, e.g., associated RACH preamble/resource. Due to the linkage between the SSB and the RACH preamble/resource the base station 102 is aware of the selected beam. For example, if the selected SSB/beam has changed compared to the initial SSB evaluation/selection during the RACH procedure or the previous selected SSB/beam, the UE 104 indicates to the base station 102 the newly selected SSB/beam. In one or more implementations, the UE 104 triggers a random access procedure where the UE 104 transmits the preamble/resource associated with the selected SSB/beam. Additionally or alternatively, the UE 104 triggers the transmission of a beam candidate MAC CE which indicates the selected SSB/Beam, e.g. index/ID of the selected SSB. Additionally or alternatively, the MAC CE signals the index of the SSBs whose SS-RSRPs are above the configured threshold. By way of another example, the UE 104 informs the base station 102 about a new SSB/beam if the RSRP of the current (selected) serving beam drops by a preconfigured threshold. If there is no UL-SCH resource available for the transmission of the beam candidate MAC CE, the UE 104 triggers a random access procedure or an SR for beam candidate indication in order to request UL-SCH resources for the transmission of the beam candidate MAC CE.

The base station 102 receives the beam information from the UE 104 and considers the beam information in subsequent data transmission to the UE. The base station 102 considers the beam information using any of a variety of public or proprietary techniques. For example, the base station 102 may use a serving beam identified in the beam information for subsequent data transmission to the UE.

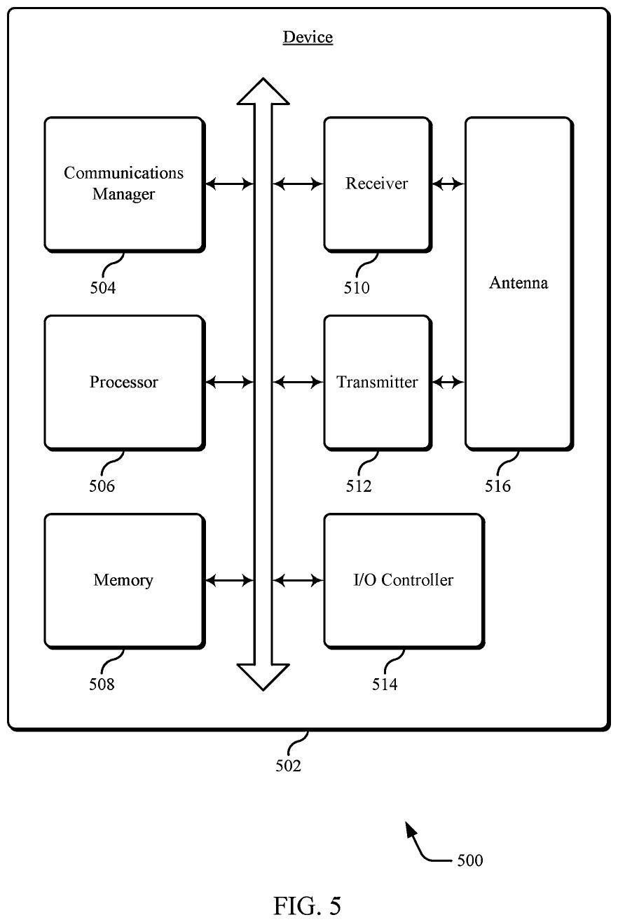

FIG. 5 illustrates an example of a block diagram 500 of a device 502 that supports beam management for data transmission in an inactive state in accordance with aspects of the present disclosure. The device 502 may be an example of a UE 104 as described herein. The device 502 may support wireless communication with one or more base stations 102, UEs 104, or any combination thereof. The device 502 may include components for bi-directional communications including components for transmitting and receiving communications, such as a communications manager 504, a processor 506, a memory 508, a receiver 510, a transmitter 512, and an I/O controller 514. These components may be in electronic communication or otherwise coupled (e.g., operatively, communicatively, functionally, electronically, electrically) via one or more interfaces (e.g., buses).

The communications manager 504, the receiver 510, the transmitter 512, or various combinations thereof or various components thereof may be examples of means for performing various aspects of the present disclosure as described herein. For example, the communications manager 504, the receiver 510, the transmitter 512, or various combinations or components thereof may support a method for performing one or more of the functions described herein.

In some implementations, the communications manager 504, the receiver 510, the transmitter 512, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 506 and the memory 508 coupled with the processor 506 may be configured to perform one or more of the functions described herein (e.g., by executing, by the processor 506, instructions stored in the memory 508).

Additionally or alternatively, in some implementations, the communications manager 504, the receiver 510, the transmitter 512, or various combinations or components thereof may be implemented in code (e.g., as communications management software or firmware) executed by the processor 506. If implemented in code executed by the processor 506, the functions of the communications manager 504, the receiver 510, the transmitter 512, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 504 may be configured to perform various operations (e.g., receiving, monitoring, transmitting) using or otherwise in cooperation with the receiver 510, the transmitter 512, or both. For example, the communications manager 504 may receive information from the receiver 510, send information to the transmitter 512, or be integrated in combination with the receiver 510, the transmitter 512, or both to receive information, transmit information, or perform various other operations as described herein. Although the communications manager 504 is illustrated as a separate component, in some implementations, one or more functions described with reference to the communications manager 504 may be supported by or performed by the processor 506, the memory 508, or any combination thereof. For example, the memory 508 may store code, which may include instructions executable by the processor 506 to cause the device 502 to perform various aspects of the present disclosure as described herein, or the processor 506 and the memory 508 may be otherwise configured to perform or support such operations.

For example, the communications manager 504 may support wireless communication at a device (e.g., the device 502, a UE) in accordance with examples as disclosed herein. The communications manager 504 and/or other device components may be configured as or otherwise support an apparatus, such as a UE, including a transmitter; and a processor coupled to the transmitter, the processor and the transmitter configured to cause the apparatus to: trigger transmission of beam information to a base station in response to a current serving beam for transmitting data between the apparatus and the base station having changed while the apparatus is in a radio resource control inactive state, the beam information indicating a new serving beam; and initiate a random access procedure and transmit the beam information to the base station as part of the random access procedure.

Additionally, the apparatus (e.g., a UE) includes any one or combination of: where the apparatus triggers transmission of the beam information to the base station in response to the serving beam for reception of downlink data having changed while the apparatus is in a small data transmission session with the base station and in the radio resource control inactive state; where the beam information includes a channel-state information reference signal index corresponding to the new serving beam; where the beam information includes a synchronization signal block index corresponding to the new serving beam; where the beam information is transmitted within a medium access control control element indicating one or more candidate beam information; where the candidate beam information is comprised of a synchronization signal block index corresponding to a new candidate beam or a channel-state information reference signal index corresponding to a new candidate beam or a combination thereof; where the beam information includes, as the information indicating the new serving beam, an identity of a candidate downlink transmission beam; where the processor and the transmitter are further configured to cause the apparatus to trigger transmission of the beam information in response to determining that the current serving beam has a synchronization signal block with a reference signal received power below a threshold; where to initiate the random access procedure is to trigger a contention free random access to identify the new serving beam to the base station; where the processor and the transmitter are further configured to cause the apparatus to: receive, from the base station, a beam measurement configuration including a periodicity; and check whether to trigger beam measurements to determine whether the current serving beam has changed at the periodicity indicated in the beam measurement configuration; where to check whether to trigger transmission of the beam information is to measure one or more reference signals in order to determine whether to trigger transmission of the beam information; where to check whether to trigger transmission of the beam information is to measure one or more reference signals for an uplink configured grant small data transmission resource the apparatus is configured with regardless of whether data is to be transmitted on the uplink configured grant small data transmission; where the beam information includes a medium access control control element identifying the new serving beam; where the beam information includes a medium access control control element identifying the new serving beam, and where the processor and the transmitter are configured to cause the apparatus to trigger a random access procedure or a scheduling request to request uplink shared channel resources if there is currently no uplink shared channel resource available for transmission; where the processor and the transmitter are further configured to cause the apparatus to, during a random access channel small data transmission session: check, at a configured periodicity, whether to trigger transmission of the beam information by determining whether the current serving beam has a synchronization signal block with a reference signal received power below a threshold; and in response to determining the current serving beam has a synchronization signal block with an reference signal received power below a threshold, initiate the random access procedure and transmit an indication of the new serving beam to the base station in a random access channel preamble; where the apparatus transmits the beam information to the base station during a random access channel small data transmission session by including a random access channel preamble corresponding to the new serving beam.

The communications manager 504 and/or other device components may be configured as or otherwise support a means for wireless communication at a UE, including triggering transmission of beam information to a base station in response to a current serving beam for transmitting data between the user equipment and the base station having changed while the user equipment is in a radio resource control inactive state, the beam information indicating a new serving beam; initiating a random access procedure; and transmitting the beam information to the base station as part of the random access procedure.

Additionally, wireless communication at the UE includes any one or combination of: where the triggering comprises triggering transmission of the beam information to the base station in response to the serving beam for reception of downlink data having changed while the user equipment is in a small data transmission session with the base station and in the radio resource control inactive state; where the beam information includes a channel state information reference signal index corresponding to the new serving beam; where the beam information includes a synchronization signal block index corresponding to the new serving beam; where the beam information is transmitted within a medium access control control element indicating one or more candidate beam information; where the candidate beam information is comprised of a synchronization signal block index corresponding to a new candidate beam or a channel-state information reference signal index corresponding to a new candidate beam or a combination thereof; where the beam information includes, as the information indicating the new serving beam, an identity of a candidate downlink transmission beam; where the triggering comprises triggering transmission of the beam information in response to determining that the current serving beam has a synchronization signal block with a reference signal received power below a threshold; the initiating the random access procedure including triggering a contention free random access to identify the new serving beam to the base station; further including: receiving, from the base station, a beam measurement configuration including a periodicity; and checking whether to trigger beam measurements to determine whether the current serving beam has changed at the periodicity indicated in the beam measurement configuration; the checking including measuring one or more reference signals in order to determine whether to trigger transmission of the beam information; the checking including measuring one or more reference signals for an uplink configured grant small data transmission resource the user equipment is configured with regardless of whether data is to be transmitted on the configured grant small data transmission; where the beam information includes a medium access control control element identifying the new serving beam; where the beam information includes a medium access control control element identifying the new serving beam, the method further including triggering the user equipment to trigger a random access procedure or a scheduling request to request uplink shared channel resources if there is currently no uplink shared channel resource available for transmission; further including, during a random access channel small data transmission session: checking, at a configured periodicity, whether to trigger transmission of the beam information by determining whether the current serving beam has a synchronization signal block with an reference signal received power below a threshold; and in response to determining the current serving beam has a synchronization signal block with a reference signal received power below a threshold, initiating the random access procedure and transmitting an indication of the new serving beam to the base station in a RACH preamble; the transmitting including transmitting the beam information to the base station during a random access channel small data transmission session by including a RACH preamble corresponding to the new serving beam.

The processor 506 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 506 may be configured to operate a memory array using a memory controller. In some other implementations, a memory controller may be integrated into the processor 506. The processor 506 may be configured to execute computer-readable instructions stored in a memory (e.g., the memory 508) to cause the device 502 to perform various functions of the present disclosure.

The memory 508 may include random access memory (RAM) and read-only memory (ROM). The memory 508 may store computer-readable, computer-executable code including instructions that, when executed by the processor 506 cause the device 502 to perform various functions described herein. The code may be stored in a non-transitory computer-readable medium such as system memory or another type of memory. In some implementations, the code may not be directly executable by the processor 506 but may cause a computer (e.g., when compiled and executed) to perform functions described herein. In some implementations, the memory 508 may include, among other things, a basic I/O system (BIOS) which may control basic hardware or software operation such as the interaction with peripheral components or devices.

The I/O controller 514 may manage input and output signals for the device 502. The I/O controller 514 may also manage peripherals not integrated into the device 502. In some implementations, the I/O controller 514 may represent a physical connection or port to an external peripheral. In some implementations, the I/O controller 514 may utilize an operating system such as iOS®, ANDROID®, MS-DOS®, MS-WINDOWS®, OS/2®, UNIX®, LINUX®, or another known operating system. In some implementations, the I/O controller 514 may be implemented as part of a processor, such as the processor 506. In some implementations, a user may interact with the device 502 via the I/O controller 514 or via hardware components controlled by the I/O controller 514.

In some implementations, the device 502 may include a single antenna 516. However, in some other implementations, the device 502 may have more than one antenna 516, which may be capable of concurrently transmitting or receiving multiple wireless transmissions. The receiver 510 and the transmitter 512 may communicate bi-directionally, via the one or more antennas 516, wired, or wireless links as described herein. For example, the receiver 510 and the transmitter 512 may represent a wireless transceiver and may communicate bi-directionally with another wireless transceiver. The transceiver may also include a modem to modulate the packets, to provide the modulated packets to one or more antennas 516 for transmission, and to demodulate packets received from the one or more antennas 516.

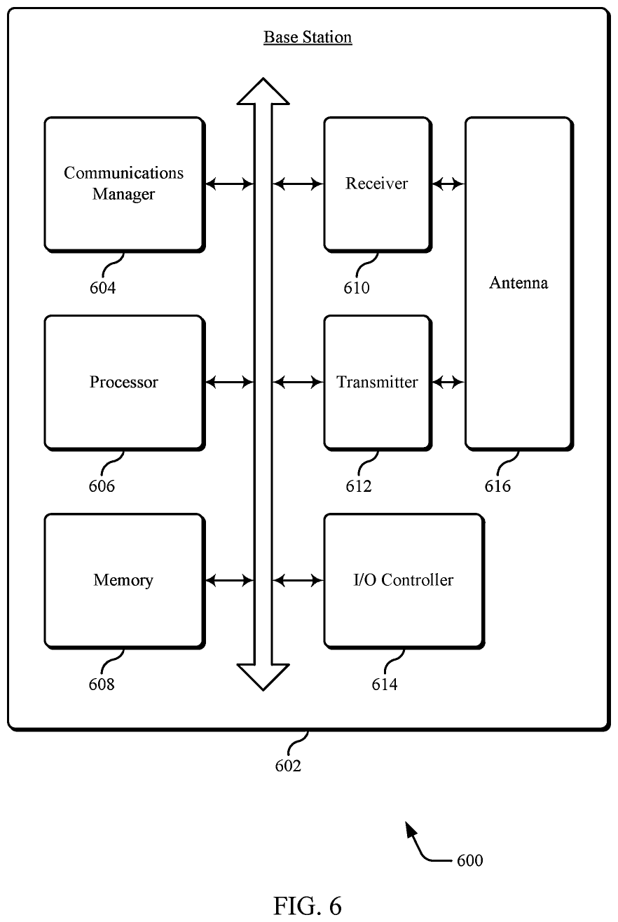

FIG. 6 illustrates an example of a block diagram 600 of a device 602 that supports beam management for data transmission in an inactive state in accordance with aspects of the present disclosure. The device 602 may be an example of a base station 102, such as a gNB as described herein. The device 602 may support wireless communication and/or network signaling with one or more base stations 102, UEs 104, or any combination thereof. The device 602 may include components for bi-directional communications including components for transmitting and receiving communications, such as a communications manager 604, a processor 606, a memory 608, a receiver 610, a transmitter 612, and an I/O controller 614. These components may be in electronic communication or otherwise coupled (e.g., operatively, communicatively, functionally, electronically, electrically) via one or more interfaces (e.g., buses).

The communications manager 604, the receiver 610, the transmitter 612, or various combinations thereof or various components thereof may be examples of means for performing various aspects of the present disclosure as described herein. For example, the communications manager 604, the receiver 610, the transmitter 612, or various combinations or components thereof may support a method for performing one or more of the functions described herein.

In some implementations, the communications manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally or alternatively, in some implementations, the communications manager 604, the receiver 610, the transmitter 612, or various combinations or components thereof may be implemented in code (e.g., as communications management software or firmware) executed by the processor 606. If implemented in code executed by the processor 606, the functions of the communications manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 604 may be configured to perform various operations (e.g., receiving, monitoring, transmitting) using or otherwise in cooperation with the receiver 610, the transmitter 612, or both. For example, the communications manager 604 may receive information from the receiver 610, send information to the transmitter 612, or be integrated in combination with the receiver 610, the transmitter 612, or both to receive information, transmit information, or perform various other operations as described herein. Although the communications manager 604 is illustrated as a separate component, in some implementations, one or more functions described with reference to the communications manager 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the communications manager 604 may support wireless communication at a device (e.g., the device 602, base station) in accordance with examples as disclosed herein. The communications manager 604 and/or other device components may be configured as or otherwise support an apparatus, such as a base station, including a transceiver; and a processor coupled to the transceiver, the processor and the transceiver configured to cause the apparatus to: receive beam information from a user equipment, the beam information being received in response to the user equipment having detected that a current serving beam for transmitting data between the apparatus and the user equipment changed while the user equipment is in a radio resource control inactive state, the beam information indicating a new serving beam; and consider the beam information for subsequent data transmissions to the user equipment.

Additionally, the apparatus (e.g., a base station) includes any one or combination of: where the beam information is transmitted within a medium access control control element indicating one or more candidate beam information; where the processor and the transceiver are further configured to cause the apparatus to transmit, to the user equipment, a beam measurement configuration including a periodicity indicating a periodicity at which the user equipment is to check whether to trigger transmission of the beam information to the apparatus; where the indication of beam information is received while the apparatus is in a small data transmission session with the user equipment; where the beam information includes a channel state information reference signal index corresponding to the new serving beam; where the beam information includes a synchronization signal block index corresponding to the new serving beam; where the beam information includes, as the information indicating the new serving beam, an identity of a candidate downlink transmission beam.

The communications manager 604 and/or other device components may be configured as or otherwise support a means for wireless communication at a base station, including receiving beam information from a user equipment, the beam information being received in response to the user equipment having detected that a current serving beam for transmitting data between the base station and the user equipment changed while the user equipment is in a radio resource control inactive state, the beam information indicating a new serving beam; and considering the beam information for subsequent data transmissions to the user equipment.

Additionally, wireless communication at the base station includes any one or combination of: where the beam information is transmitted within a medium access control control element indicating one or more candidate beam information; further including: determining a periodicity at which the user equipment is to check whether to trigger transmission of the beam information to the base station; and transmitting, to the user equipment, a beam measurement configuration including the periodicity; where the indication of beam information is received while the base station is in a small data transmission session with the user equipment; where the beam information includes a channel state information reference signal index corresponding to the new serving beam; where the beam information includes a synchronization signal block index corresponding to the new serving beam; where the beam information includes, as the information indicating the new serving beam, an identity of a candidate downlink transmission beam.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

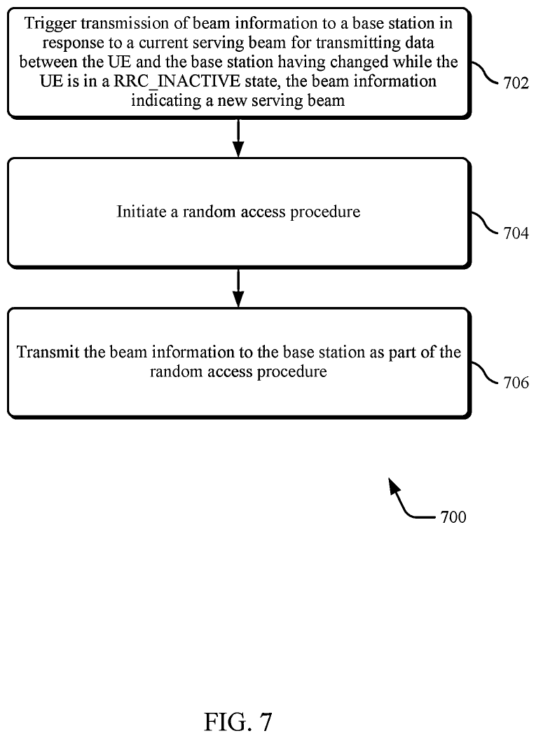

FIG. 7 illustrates a flowchart of a method 700 that supports beam management for data transmission in an inactive state in accordance with aspects of the present disclosure. The operations of the method 700 may be implemented by a device or its components as described herein. For example, the operations of the method 700 may be performed by a device, such as UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 702, the method may include triggering transmission of beam information to a base station in response to a current serving beam for transmitting data between the UE and the base station having changed while the UE is in a RRC_INACTIVE state, the beam information indicating a new serving beam. The operations of 702 may be performed in accordance with examples as described herein. In some implementations, aspects of the operations of 702 may be performed by a device as described with reference to FIG. 1.

At 704, the method may include initiating a random access procedure. The operations of 704 may be performed in accordance with examples as described herein. In some implementations, aspects of the operations of 704 may be performed by a device as described with reference to FIG. 1.

At 706, the method may include transmitting the beam information to the base station as part of the random access procedure. The operations of 706 may be performed in accordance with examples as described herein. In some implementations, aspects of the operations of 706 may be performed by a device as described with reference to FIG. 1.

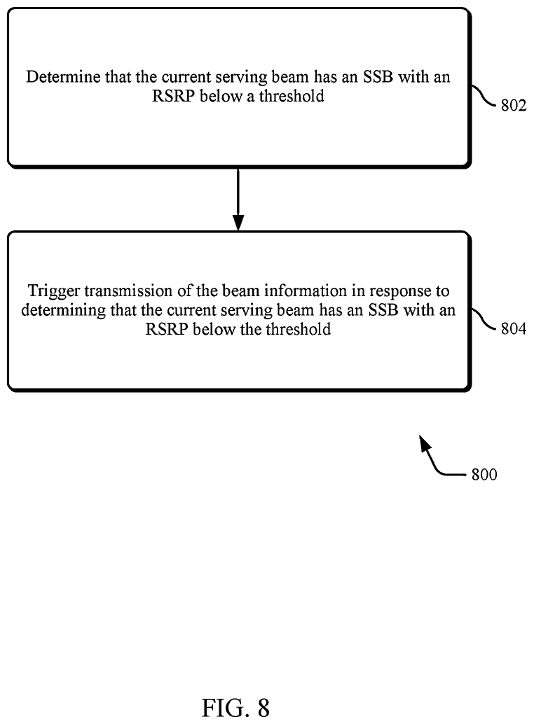

FIG. 8 illustrates a flowchart of a method 800 that supports beam management for data transmission in an inactive state in accordance with aspects of the present disclosure. The operations of the method 800 may be implemented by a device or its components as described herein. For example, the operations of the method 800 may be performed by a base station 102, such as a gNB as described with reference to FIGS. 1 through 6. In some implementations, the device may execute a set of instructions to control the function elements of the device to perform the described functions. Additionally, or alternatively, the device may perform aspects of the described functions using special-purpose hardware.

At 802, the method may include determining that the current serving beam has an SSB with an RSRP below a threshold. The operations of 802 may be performed in accordance with examples as described herein. In some implementations, aspects of the operations of 802 may be performed by a device as described with reference to FIG. 1.

At 804, the method may include triggering transmission of the beam information in response to determining that the current serving beam has an SSB with an RSRP below the threshold. The operations of 804 may be performed in accordance with examples as described herein. In some implementations, aspects of the operations of 804 may be performed by a device as described with reference to FIG. 1.

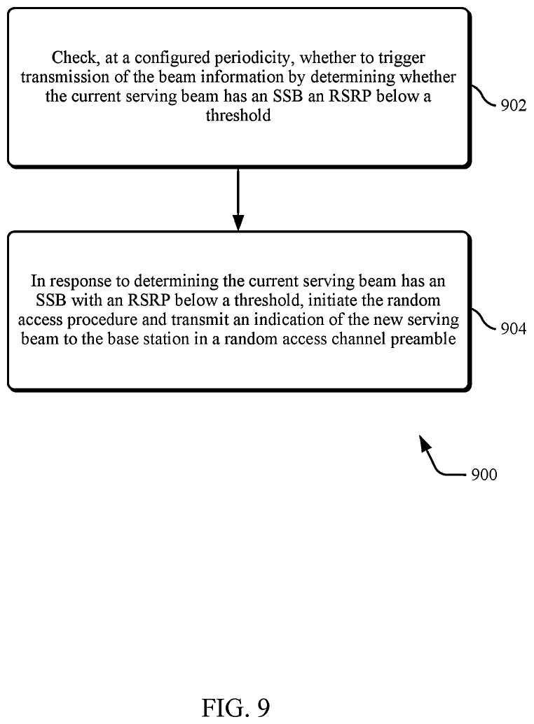

FIG. 9 illustrates a flowchart of a method 900 that supports beam management for data transmission in an inactive state in accordance with aspects of the present disclosure. The operations of the method 900 may be implemented by a device or its components as described herein. For example, the operations of the method 900 may be performed by a base station 102, such as a gNB as described with reference to FIGS. 1 through 6. In some implementations, the device may execute a set of instructions to control the function elements of the device to perform the described functions. Additionally, or alternatively, the device may perform aspects of the described functions using special-purpose hardware.

At 902, the method may include checking, at a configured periodicity, whether to trigger transmission of the beam information by determining whether the current serving beam has an SSB an RSRP below a threshold. The operations of 902 may be performed in accordance with examples as described herein. In some implementations, aspects of the operations of 902 may be performed by a device as described with reference to FIG. 1.

At 904, the method may include in response to determining the current serving beam has an SSB with an RSRP below a threshold, initiating the random access procedure and transmit an indication of the new serving beam to the base station in a random access channel preamble. The operations of 904 may be performed in accordance with examples as described herein. In some implementations, aspects of the operations of 904 may be performed by a device as described with reference to FIG. 1.

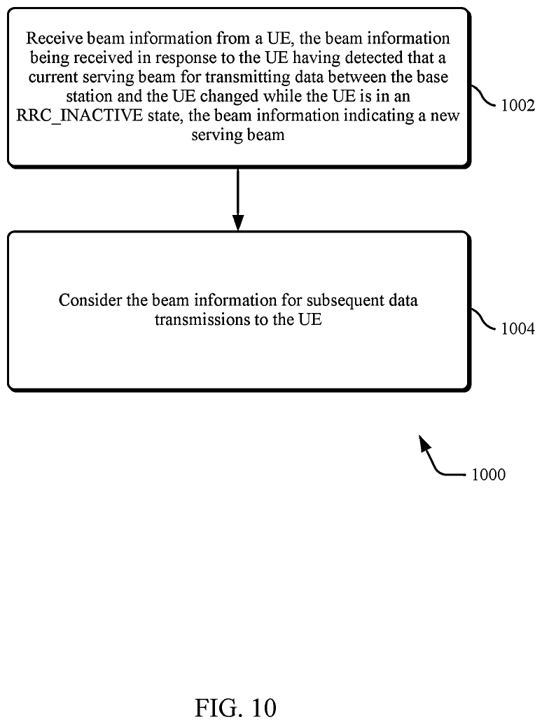

FIG. 10 illustrates a flowchart of a method 1000 that supports beam management for data transmission in an inactive state in accordance with aspects of the present disclosure. The operations of the method 1000 may be implemented by a device or its components as described herein. For example, the operations of the method 1000 may be performed by a base station 102, such as a gNB as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1002, the method may include receiving beam information from a UE, the beam information being received in response to the UE having detected that a current serving beam for transmitting data between the base station and the UE changed while the UE is in an RRC_INACTIVE state, the beam information indicating a new serving beam. The operations of 1002 may be performed in accordance with examples as described herein. In some implementations, aspects of the operations of 1002 may be performed by a device as described with reference to FIG. 1.

At 1004, the method may include considering the beam information for subsequent data transmissions to the UE. The operations of 1004 may be performed in accordance with examples as described herein. In some implementations, aspects of the operations of 1004 may be performed by a device as described with reference to FIG. 1.

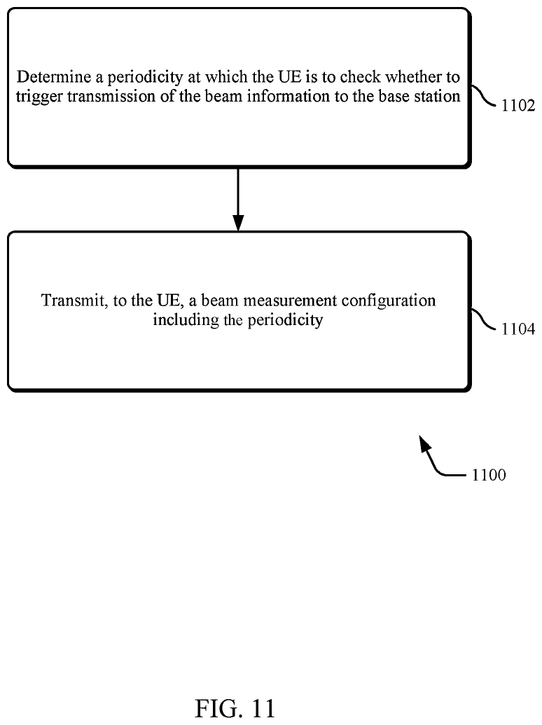

FIG. 11 illustrates a flowchart of a method 1100 that supports beam management for data transmission in an inactive state in accordance with aspects of the present disclosure. The operations of the method 1100 may be implemented by a device or its components as described herein. For example, the operations of the method 1100 may be performed by a base station 102, such as a gNB as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1102, the method may include determining a periodicity at which the UE is to check whether to trigger transmission of the beam information to the base station. The operations of 1102 may be performed in accordance with examples as described herein. In some implementations, aspects of the operations of 1102 may be performed by a device as described with reference to FIG. 1.

At 1104, the method may include transmitting, to the UE, a beam measurement configuration including the periodicity. The operations of 1104 may be performed in accordance with examples as described herein. In some implementations, aspects of the operations of 1104 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
trigger transmission of beam information to a base station in response to a current serving beam for transmitting data between the UE and the base station having changed while the UE is in a radio resource control inactive state, the beam information indicating a new serving beam; and
initiate a random access procedure and transmit the beam information to the base station as part of the random access procedure.

2. The UE of claim 1, wherein the at least one processor is further configured to cause the UE to trigger transmission of the beam information to the base station in response to the serving beam for reception of downlink data having changed while the UE is in a small data transmission session with the base station and in the radio resource control inactive state.

3. The UE of claim 1, wherein the beam information includes a channel-state information reference signal index corresponding to the new serving beam.

4. The UE of claim 1, wherein the beam information includes a synchronization signal block index corresponding to the new serving beam.

5. The UE of claim 1, wherein at least one processor is further configured to cause the UE to transmit the beam information within a medium access control control element indicating one or more candidate beam information.

6. The UE of claim 5, wherein the candidate beam information is comprised of a synchronization signal block index corresponding to a new candidate beam or a channel-state information reference signal index corresponding to a new candidate beam or a combination thereof.

7. The UE of claim 1, wherein the beam information includes, as the information indicating the new serving beam, an identity of a candidate downlink transmission beam.

8. The UE of claim 1, wherein the at least one processor is further configured to cause the UE to trigger transmission of the beam information in response to determining that the current serving beam has a synchronization signal block with a reference signal received power below a threshold.

9. The UE of claim 8, wherein to initiate the random access procedure is to trigger a contention free random access to identify the new serving beam to the base station.

10. The UE of claim 1, wherein the at least one processor is further configured to cause the UE to:
receive, from the base station, a beam measurement configuration including a periodicity; and
check whether to trigger beam measurements to determine whether the current serving beam has changed at the periodicity indicated in the beam measurement configuration.

11. The UE of claim 10, wherein to check whether to trigger transmission of the beam information is to measure one or more reference signals in order to determine whether to trigger transmission of the beam information.

12. The UE of claim 1, wherein to check whether to trigger transmission of the beam information is to measure one or more reference signals for an uplink configured grant small data transmission resource the UE is configured with regardless of whether data is to be transmitted on the uplink configured grant small data transmission.

13. The UE of claim 12, wherein the beam information includes a medium access control control element identifying the new serving beam.

14. (canceled)

15. (canceled)

16. (canceled)

17. A base station for wireless communication, comprising:
at least one memory; and
at least one processor coupled with the at least one memory and configured to cause the base station to:
receive beam information from a user equipment (UE), the beam information being received in response to the UE having detected that a current serving beam for transmitting data between the base station and the UE changed while the UE is in a radio resource control inactive state, the beam information indicating a new serving beam; and
consider the beam information for subsequent data transmissions to the UE.

18. The base station of claim 17, wherein the beam information is transmitted within a medium access control control element indicating one or more candidate beam information.

19. Thes base station of claim 17, wherein the at least one processor is further configured to cause the base station to transmit, to the UE, a beam measurement configuration including a periodicity indicating a periodicity at which the UE is to check whether to trigger transmission of the beam information to the base station.

20. A method for wireless communication at a user equipment (UE), the method comprising:
triggering transmission of beam information to a base station in response to a current serving beam for transmitting data between the UE and the base station having changed while the UE is in a radio resource control inactive state, the beam information indicating a new serving beam;
initiating a random access procedure; and
transmitting the beam information to the base station as part of the random access procedure.

21. A processor for wireless communication, comprising:
at least one controller coupled with at least one memory and configured to cause the processor to:
trigger transmission of beam information to a base station in response to a current serving beam for transmitting data between the processor and the base station having changed while the processor is in a radio resource control inactive state, the beam information indicating a new serving beam; and
initiate a random access procedure and transmit the beam information to the base station as part of the random access procedure.

22. The processor of claim 21, wherein the at least one controller is further configured to cause the processor to trigger transmission of the beam information to the base station in response to the serving beam for reception of downlink data having changed while the processor is in a small data transmission session with the base station and in the radio resource control inactive state.

23. The processor of claim 21, wherein the beam information includes a channel-state information reference signal index corresponding to the new serving beam.
